(19) United States
(12) Patent Application Publication
(10) Pub. No.: US 2017/0094064 A1
(43) Pub. Date: Mar. 30, 2017

(54) ELECTRONIC APPARATUS AND CONTROL METHOD THEREOF

(71) Applicant: SAMSUNG ELECTRONICS CO., LTD., Suwon-si (KR)

(72) Inventor: Ki-hun KIM, Suwon-si (KR)

(21) Appl. No.: 15/258,093

(22) Filed: Sep. 7, 2016

(30) Foreign Application Priority Data
Sep. 25, 2015 (KR) 10-2015-0136721

(51) Int. Cl. H04M 11/00; H04W 76/02; H04W 40/00

(52) U.S. Cl. CPC H04M 11/007; H04W 40/005; H04W 76/025; H04W 88/08

(57) ABSTRACT

An electronic apparatus is provided. The electronic apparatus includes a communication module comprising communication circuitry configured to communicate with an external apparatus, and a processor configured to control the communication circuitry of the communication module to search for an external apparatus connectable with the electronic apparatus, to transmit a wake-up packet to the searched external apparatus, and in response to a mode of the external apparatus being changed to an operation mode by the wake-up packet, perform a communication connection with the external apparatus.

### CROSS-REFERENCE TO RELATED APPLICATIONS

This application is based on and claims priority under 35 U.S.C. §119 to Korean Patent Application No. 10-2015-0136721, filed in the Korean Intellectual Property Office on Sep. 25, 2015, the disclosure of which is incorporated by reference herein in its entirety.

### BACKGROUND

1. Field

The present disclosure relates to an electronic apparatus and a control method thereof, and for example, to an electronic apparatus which transmits a wake-up packet to an external apparatus and a control method thereof.

2. Description of Related Art

As electronic technology develops, various methods to turn on an external apparatus are developed. At present, an external apparatus is turned on or a sleep mode of the external apparatus is changed to an operation mode by transmitting data (magic packet) which includes an ID of the external apparatus to the external apparatus.

In other words, at present, an external apparatus is turned on or a mode of the external apparatus is changed to an operation mode by broadcasting a specific form of data including a MAC address of the external apparatus to turn on the external apparatus or to change a mode of the external apparatus to the operation mode.

However, at present, since an external apparatus is controlled using a method of wake-on-wireless local area network (WoWLAN) which uses Wi-Fi, an electronic apparatus and an external apparatus should be previously connected to an access point (AP).

Specifically, in order to use the current method, an electronic apparatus (a waker) should be connected to an AP to transmit a wake-up packet to change a mode of an external apparatus (a wakee) to an operation mode as illustrated in FIG. 1A.

However, since a connection with an AP should be preceded, there are problems that when an external apparatus cannot be connected to an AP in a sleep mode, the external apparatus should be connected to an AP before being in the sleep mode and when the connection with the AP is canceled in the sleep mode, the external apparatus cannot restore the connection with the AP. Also, there is a problem that it is hard to embody with low power since process gets longer when the external apparatus should be connected to the AP in the sleep mode.

Also, there is a problem that the WoWLAN cannot be used when an AP does not exist as illustrated in FIG. 1B.

Accordingly, a method of transmitting a wake-up packet to an external apparatus without an AP as illustrated in FIG. 1C is required.

### SUMMARY

An aspect of the example embodiments relates to an electronic apparatus which can change a mode of an external apparatus to an operation mode by transmitting a wake-up packet to the external apparatus before performing a communication connection with the external apparatus and a control method thereof.

An aspect of example embodiments relates to an electronic apparatus including a communication module comprising communication circuitry configured to communicate with an external apparatus and a processor configured to control the communication circuitry of the communication module to search for an external apparatus connectable with the electronic apparatus, to transmit a wake-up packet to the external apparatus identified by the search, and in response to a mode of the external apparatus being changed to an operation mode by the wake-up packet, to perform a communication connection with the external apparatus.

Herein, the processor may control the communication module to transmit a first probe request packet to the external apparatus and receive a probe response packet corresponding to the first probe request packet from the external apparatus in order to search for the external apparatus.

Herein, the processor may, in response to a probe response packet corresponding to the first probe request packet being received from the external apparatus, control the communication module to include and transmit a wake-up packet in a second probe request packet.

Herein, the processor may control the communication module to add and transmit the wake-up packet in a vendor specific information element included in the second probe request packet.

Also, the processor may, in response to a probe request packet being received from the external apparatus, control the communication module to transmit a probe response packet corresponding to the probe request packet in order to search for the external apparatus.

Herein, the processor may, in response to a probe request packet being received from the external apparatus, control the communication module to include and transmit a wake-up packet in a probe response packet corresponding to the probe request packet.

Also, the processor may, in response to there being the plurality of searched external apparatuses, control the communication module to transmit a wake-up packet to each of the plurality of external apparatuses and perform a communication connection with an external apparatus of which mode is changed to an operation mode from among the plurality of external apparatuses.

Also, the communication module may include a Wi-Fi P2P module.

Meanwhile, an aspect of example embodiments relates to a system including an electronic apparatus configured to search for an external apparatus connectable with the electronic apparatus, to transmit a wake-up packet to the external apparatus identified by the search, and in response to a mode of the external apparatus being changed to an operation mode by the wake-up packet, to perform a communication connection with the external apparatus, and an external apparatus configured to change a mode to an operation mode in response to the wake-up packet being received from the electronic apparatus.

Herein, the electronic apparatus may transmit a probe request packet including the wake-up packet to the external apparatus, and the external apparatus, in response to the probe request packet being received from the electronic apparatus, transmits a probe response packet corresponding to the probe request packet to the electronic apparatus.

Also, the external apparatus may, in response to a mode of the external apparatus being a sleep mode, only periodically perform a listening operation, and in response to the probe request packet being received from the electronic apparatus in a listening status, transmit a probe response packet corresponding to the probe request packet to the electronic apparatus.

Meanwhile, an aspect of example embodiments relates to a method of controlling an electronic apparatus, the method including searching for an external apparatus connectable with the electronic apparatus, transmitting a wake-up packet to an identified external apparatus and in response to a mode of the external apparatus being changed to an operation mode by the wake-up packet, performing a communication connection with the external apparatus.

Herein, the searching may include transmitting a first probe request packet to the external apparatus and receiving a probe response packet corresponding to the first probe request packet from the external apparatus in order to search for the external apparatus.

Herein, the transmitting may, in response to a probe response packet corresponding to the first probe request packet being received from the external apparatus, include including and transmitting a wake-up packet in a second probe request packet.

Herein, the transmitting may include adding and transmitting the wake-up packet in a vendor specific information element included in the second probe request packet.

Also, the searching may, in response to a probe request packet being received from the external apparatus, include transmitting a probe response packet corresponding to the probe request packet in order to search for the external apparatus.

Herein, the transmitting may, in response to a probe request packet being received from the external apparatus, include including and transmitting a wake-up packet in a probe response packet corresponding to the probe request packet.

Also, the transmitting may, in response to there being the plurality of searched external apparatuses being identified, include transmitting a wake-up packet to each of the plurality of external apparatuses, and wherein the performing comprises performing a communication connection with an external apparatus of which mode is changed to an operation mode among the plurality of external apparatuses.

Also, the performing may include performing a communication connection with the external apparatus by using a Wi-Fi P2P module.

According to the various example embodiments, even in case that an electronic apparatus and an external apparatus are not connected to an access point, a wake-up packet can be transmitted and therefore, a convenience for a user is improved.

### BRIEF DESCRIPTION OF THE DRAWINGS

These and/or other aspects of the disclosure will be more apparent and readily appreciated from the following detailed description, taken in conjunction with the accompanying drawings, in which like reference numerals refer to like elements, and wherein:

FIGS. 1A, 1B and 1C are diagrams illustrating a problem of an existing technology;

FIG. 2 is a diagram illustrating an example configuration of a wake-up system according to an example embodiment;

FIG. 3 is a block diagram illustrating an example configuration of an electronic apparatus according to an example embodiment;

FIGS. 4 and 5 are block diagrams illustrating an example configuration of an electronic apparatus according to an example embodiment;

FIG. 6 is a block diagram illustrating an example configuration of an external apparatus according to an example embodiment;

FIG. 7 is a diagram illustrating an example method of transceiving a packet with an external apparatus according to an example embodiment;

FIGS. 8A, 8B and 8C are diagrams illustrating an example method of transmitting a wake-up packet according to an example embodiment;

FIG. 9 is a diagram illustrating an example operation when an external apparatus is in a sleep mode according to an example embodiment;

FIG. 10 is a diagram illustrating an example method of adding a wake-up packet to a probe request packet according to an example embodiment; and

FIG. 11 is a flowchart illustrating an example method of controlling an electronic apparatus according to an example embodiment.

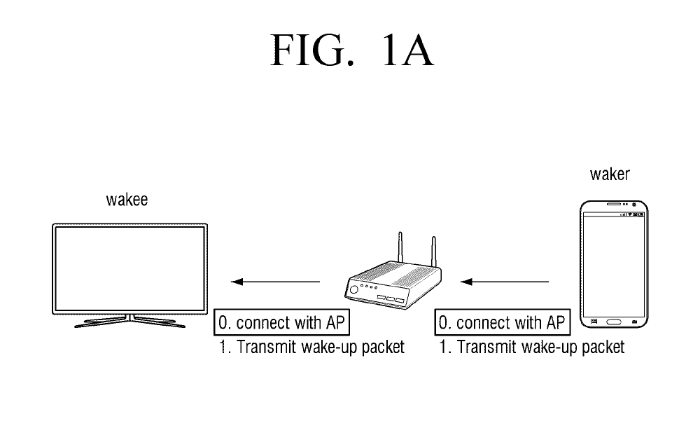

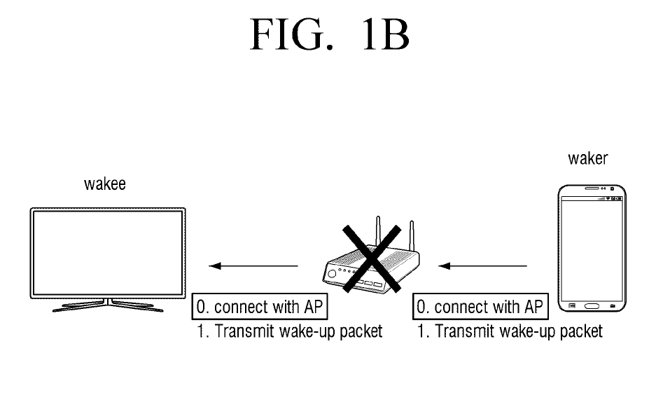

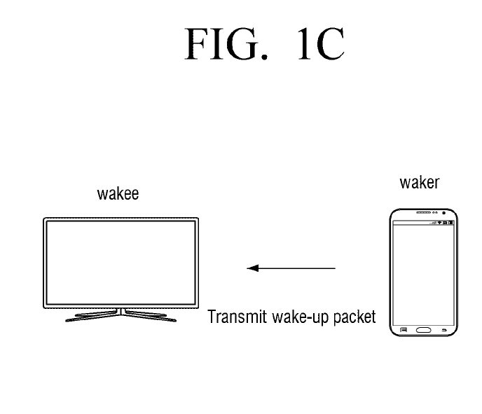

### DETAILED DESCRIPTION

Certain example embodiments are described in greater detail below with reference to the accompanying drawings.

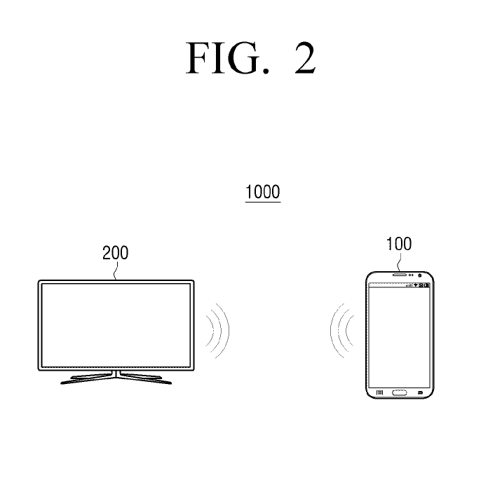

FIG. 2 is a diagram illustrating an example configuration of a wake-up system according to an example embodiment.

FIG. 2 illustrates a system 1000 according to an example embodiment that includes an electronic apparatus 100 and an external apparatus 200.

The electronic apparatus 100 may refer, for example, to an apparatus to remotely control the external apparatus 200 and may transmit a wake-up packet to the external apparatus 200 to change a sleep mode of the external apparatus 200 to an operation mode. The electronic apparatus 100 according to an example embodiment may be embodied as a smartphone but if the electronic apparatus is an apparatus which can control an external apparatus such as a PC, the electronic apparatus 100 may be applied to any kind of apparatus without a limitation.

The external apparatus 200 may refer, for example, to an apparatus which is controlled by the electronic apparatus 100, and the external apparatus 200 may be embodied as a digital television (TV). However, if the external apparatus 200 is an apparatus which can be remotely controlled by the electronic apparatus 100, the external apparatus 200 is not limited thereto.

The electronic apparatus 100 searches for the external apparatus 200 which can be connected with the electronic apparatus 100 using a communication module including communication circuitry which communicates with the external apparatus 200. Herein, the communication module is a module to perform a wireless communication, and may include various communication circuitry, such as, for example, and without limitation, an antenna, a radio frequency (RF) transmitter, a RF receiver, a modulator, a demodulator, a signal processor and the like. The communication module may communicate with a network or with the external apparatus 200 which can communicate within Wi-Fi P2P communication by accessing an access point (AP) according to various communication standards such as Wi-Fi. Specifically, the electronic apparatus 100 may search for the external apparatus 200 which can be connected by transmitting a probe request packet to the external apparatus 200 and receiving a probe response packet from the external apparatus 200.

The electronic apparatus 100 may transmit a wake-up packet to the searched external apparatus 200. Specifically, the electronic apparatus 100 may add and transmit a wake-up packet in a probe request packet or a probe response packet, or transmit a wake-up packet as a separate packet to the external apparatus 200.

For example, the electronic apparatus 100 may transmit a wake-up packet to the external apparatus 200 by performing a Wi-Fi P2P communication. The electronic apparatus 100 may control a communication module in order to perform a device discovery which is defined in a Wi-Fi communication standard for the Wi-Fi P2P to communication. Herein, the device discovery indicates a process for two P2P devices mutually search and find the mutual devices by exchanging information on apparatuses such as a name of an apparatus, a type of the apparatus and so on.

Once the device discovery starts, the electronic apparatus 100 controls the communication module to repetitively execute a scanning operation and a finding operation. Herein, the scanning operation indicates scanning all channels which are defined in the Wi-Fi communication standards and collecting information regarding surrounding devices and network environments and the finding operation indicates a searching operation which is searching for an external apparatus and a listening operation which is searched from the external apparatus.

When the Wi-Fi P2P function is executed, the electronic apparatus 100 may control the communication module to perform a scanning operation through each channel while sequentially selecting a plurality of channels. Herein, a channel for which the scanning operation is carried out may be 2.4 GHz band or 5 GHz band which are defined in the Wi-Fi communication standard.

When the scanning operation is completed, the electronic apparatus 100 executes the finding operation by repeating the searching operation and the listening operation. Specifically, the electronic apparatus 100 may transmit a probe request packet through each of social channels (e.g., channels 1, 6 and 11) in the searching operation and control the communication module to transmit a probe response packet through each of the social channels to which the probe request packet was transmitted. In this case, the electronic apparatus 100 may convert a mode of the external apparatus 200 to an operation mode by transmitting a probe request packet including a wake-up packet.

The electronic apparatus 100 may select a channel among the social channels to receive a probe request packet that the external apparatus 200 transmits in the listening operation. In this case, the electronic apparatus 100 may perform the listening operation for a predetermined time and time to perform the listening operation may be set differently from time to perform the searching operation. When the probe request packet transmitted from the external apparatus 200 is received, the electronic apparatus 100 may control the communication module to transmit a probe response packet to the external apparatus 200. In this case, the electronic apparatus 100 may add and transmit a wake-up packet in the probe response packet.

The electronic apparatus 100 may transmit a first probe request packet to the external apparatus 200 and when a probe response packet is received from the external apparatus 200, the electronic apparatus 100 may transmit a second probe request packet including a wake-up packet. Specifically, the electronic apparatus 100 may transmit wake-up information by adding a vendor specific information element (IE) in the second probe request packet. In other words, the electronic apparatus 100 may transmit the second probe request packet including the wake-up packet and the wake-up packet may include a message, a length and the vendor specific IE including the wake-up information.

When the external apparatus 200 is in a sleep mode, a finding operation which is periodically repeating a searching operation and a listening operation may be performed. In other words, the external apparatus 200, in the searching operation, transmits a probe request packet to the electronic apparatus 100 and in the listening operation, transmits a probe response packet when the probe request packet is received from the electronic apparatus 100.

The external apparatus 200 may, in the sleep mode, not perform the searching operation but periodically perform the listening operation only. In other words, when a probe request packet is received from the electronic apparatus 100 by performing only the listening operation, the external apparatus 200 may transmit a probe response packet to the electronic apparatus 100. And then, a probe request packet including a wake-up packet may be received from the electronic apparatus 100 and a wake-up operation may be performed. Therefore, there is an effect of reducing unnecessary power consumption by the external apparatus 200 not performing the searching operation.

When the external apparatus 200 receives the wake-up packet from the electronic apparatus 100, the sleep mode of the external apparatus 200 may be converted to the operation mode. Specifically, in the sleep mode, minimum power is provided to a power of the external apparatus 200 to perform a finding operation, and when a wake-up packet is received from the electronic apparatus 100, a mode of the external apparatus 200 may be converted to the operation mode and the power which is needed for operations of the external apparatus 200 may be provided with power.

When the electronic apparatus 100 transmits a wake-up packet to the external apparatus 200 and a mode of the external apparatus is converted to the operation mode, the electronic apparatus 100 may control the communication module to execute a communication connection with the external apparatus 200. Specifically, when a device discovery process is completed, the electronic apparatus 100 may control the communication module to execute a group forming operation with the discovered external apparatus 200. Herein, the group forming operation indicates determining roles of a P2P group owner (GO) and a P2P client among apparatuses that perform the Wi-Fi P2P communication. Accordingly, an apparatus determined as a P2P GO performs a function of an access point and an apparatus determined as a P2P client performs a function of a station.

When a plurality of external apparatuses are searched, the electronic apparatus 100 may transmit a wake-up packet to each of the plurality of external apparatuses 200. Specifically, the electronic apparatus 100 may transmit a probe request packet including a wake-up packet or a probe response packet including a wake-up packet, or transmit a separate wake-up packet to each of the plurality of external apparatuses 200. The electronic apparatus 100 may control the communication module to perform a communication connection with the external apparatus 200 of which mode is converted to an operation mode among the plurality of external apparatuses 200. However, the electronic apparatus 100 may transmit a probe request packet including a wake-up packet or a probe response packet including a wake-up packet, or transmit only a separate wake-up packet to the external apparatus 200 and it is not necessary for the electronic apparatus 100 to perform a communication connection with the external apparatus 200. In other words, after a wake-up packet is transmitted to the external apparatus 200, the electronic apparatus 100 may not perform the communication connection with the external apparatus 200.

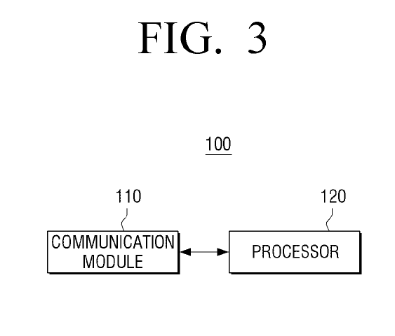

FIG. 3 is a block diagram illustrating an example configuration of an electronic apparatus according to an example embodiment.

A communication module (e.g., including communication circuitry) 110 is a module comprising communication circuitry for performing a communication with the external apparatus 200 and may include communication circuitry, such as, for example, and without limitation, a Wi-Fi module or the like to perform a Wi-Fi communication. The communication module 110 may include various configuration elements and communication circuitry for a wireless communication. For example, a Wi-Fi module may include various communication circuitry, such as, for example, and without limitation, an antenna, a radio frequency (RF) transmitter, a RF receiver, a modulator for a RF signal, a demodulator for a RF signal, a signal processor and the like. Even though the explanation is based on the assumption that the communication module 110 according to an example embodiment hereinafter is a Wi-Fi module, it is not limited hereto. The communication module 110 may be various communication modules including various communication circuitry that perform a wireless communication such as, for example, and without limitation, BlueTooth (BT), Zigbee, Infrared (IR), a serial interface, a universal serial bus (USB), near field communication (NFC) and so on.

According to a Wi-Fi communication standard, the communication module 110 may perform a communication in a network by accessing an access point (AP) or directly communicate with the external apparatus 200 which can communicate in the Wi-Fi P2P.

Specifically, the communication module 110 may transmit a probe request packet to the external apparatus 200 or transmit a probe response packet corresponding to the probe request packet received from the external apparatus 200. In this case, the communication module 110 may add and transmit a wake-up packet in the probe request packet or the probe response packet. The communication module 110 also may transmit a separate wake-up packet to the external apparatus 200.

A processor 120 controls overall operations of the electronic apparatus 100. Specifically, the processor 120 may control the communication module 110 to access an access point (AP) or to perform the Wi-Fi P2P communication with the external apparatus 200 which can communicate in the Wi-Fi P2P.

The processor 120 searches for the external apparatus 200 which can be connected with the electronic apparatus 100 and may control the communication module 110 to transmit a wake-up packet to the searched external apparatus 200. Specifically, the processor 120 may search for the external apparatus 200 by controlling the communication module 110 to transmit a first probe request packet to the external apparatus 200 and receive a probe response packet corresponding to the first probe request packet from the external apparatus 200. In this case, when the probe response packet corresponding to the first probe request packet is received, the processor 120 may control the communication module 110 to transmit a second probe request packet including a wake-up packet.

The processor 120 may control the communication module 110 to include and transmit the wake-up packet in a vendor specific IE which was added to the second probe request packet. Herein, the vendor specific IE is a packet which can be added to a probe request packet according to the P2P standard and the wake-up information may be added thereto.

The processor 120 may search for the external apparatus 200 by controlling the communication module 110 to transmit a probe response packet corresponding to a probe request packet when the probe request packet is received from the external apparatus 200. In this case, the processor 120 may control the communication module 110 to include and transmit a wake-up packet in a probe response packet corresponding to the probe request packet received from the external apparatus 200.

The processor 120 may control the communication module 110 to transmit a probe request packet or a probe response packet to a plurality of external apparatuses 200. When there being a plurality of searched external apparatuses 200, the processor 120 may transmit a wake-up packet to each of the plurality of external apparatuses. In this case, the processor 120 may include and transmit a wake-up packet in the probe request packet or the probe response packet.

According to the various example embodiments, even in case of an electronic apparatus and an external apparatus not being connected to an access point (AP), a wake-up packet can be transmitted and thus, a user's convenience may be improved.

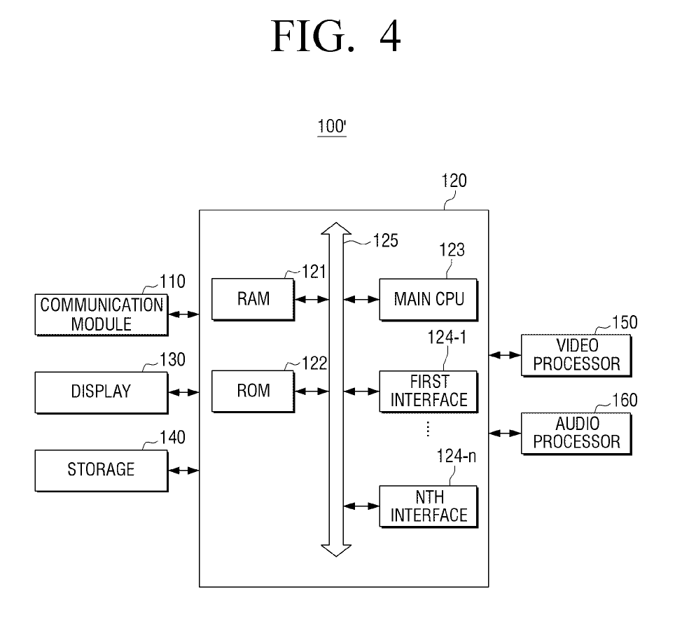

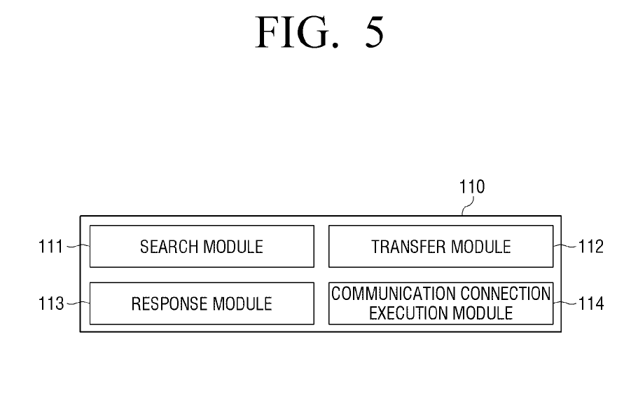

FIGS. 4 and 5 are block diagrams illustrating an example detailed configuration of an electronic apparatus according to an example embodiment.

FIG. 4 is a block diagram illustrating an example configuration of an electronic apparatus illustrated in FIG. 3. Referring to FIG. 4, an electronic apparatus 100′ includes the communication module (e.g., including communication circuitry) 110, the processor 120, a display 130, a storage 140, a video processor 150 and an audio processor 160. Detailed explanations on configurations illustrated in FIG. 4 which are repetitive to the configurations illustrated in FIG. 3 are omitted.

The processor 120 controls overall operations of the electronic apparatus 100′.

Specifically, the processor 120 includes a random access memory (RAM) 121, a read only memory (ROM) 122, a main central processing unit (CPU) 123, a first to nth interfaces 124-1 to 124-n, and a bus 125.

The RAM 121, the ROM 122, the main CPU 123, the first to nth interfaces 124-1 to 124-n, and the bus 125 may be mutually connected.

The first to nth interfaces 124-1 to 124-n are connected to the described various elements. One of the interfaces may be a network interface which is connected to an external apparatus through the network.

The main CPU 123 performs a boot by using an operating system (O/S) stored in the storage 140 by accessing the storage 140. Various operations are performed by using various programs, contents, data and the like stored in the storage 140.

An instruction set for booting a system is stored in the ROM 122. When the power is provided in response to a turn on command being input, the main CPU 123 boots a system, according to a command stored in the ROM 122, by copying an O/S stored in the storage 140 to the RAM 121 and executing the O/S. When the boot is completed, the main CPU 123 performs various operations by copying various application programs stored in the storage 140 to RAM 121 and executing the application programs copied to the RAM 121.

The operations executed by the processor 120 may be carried out by the communication module 110 as illustrated in FIG. 5.

The communication module 110 includes various modules including various circuitry for communicating with the external apparatus 200.

The communication module 110 may, as illustrated in FIG. 5, include a search module 111, a transfer module 112, a response module 113 and a communication connection execution module 114 which are needed to perform a wake-up operation of the external apparatus 200 according to an example embodiment.

The processor 120 may search for the external apparatus 200 which is connectable with the electronic apparatus 100′ by using the search module 111. Specifically, the processor 120 may search for the external apparatus 200 by transmitting a probe request packet to the external apparatus 200 by using the transmit module 112 and receiving a probe response packet corresponding to the probe request packet from the external apparatus 200. In this case, the processor 120 may control the transfer module 112 to transmit a wake-up packet in the probe request packet.

The processor 120 may search for the external apparatus 200 by using the response module 113 by transmitting a probe response packet when the probe request packet is received from the external apparatus 200. In this case, the processor 120 may control the response module 113 to include and transmit a wake-up packet in the probe response packet.

When a mode of the external apparatus 200 is changed to an operation mode by the wake-up packet, the processor 120 may perform a communication connection with the external apparatus 200 by using the communication connection execution module 114.

The display 130 may provide an user interface (UI) which can perform a wake-up operation in the external apparatus 200. Specifically, an UI to transmit a wake-up command to the external apparatus 200, an UI to indicate a current mode of the external apparatus 200 and an UI to indicate a connection status with the external apparatus 200 may be provided.

The display 130 may be embodied as a display which is one of various forms such as a liquid crystal display, an organic light-emitting diode display, a liquid crystal on silicon (LCoS) display and a digital light processing (DLP) display.

The storage 140 may store an operating system (O/S) software module for driving the electronic apparatus 100′ and various data such as all kinds of multimedia contents.

The electronic apparatus 100′ may further include the video processor 150 which processes video data, the audio processor 160 which processes audio data, a speaker which outputs various audio data which are processed in the audio processor 160, various alarming sounds and voice messages, a camera which photographs a still image or records a video according to a user's control and a microphone which receives a user's voice or guitar sound and converts it to audio data.

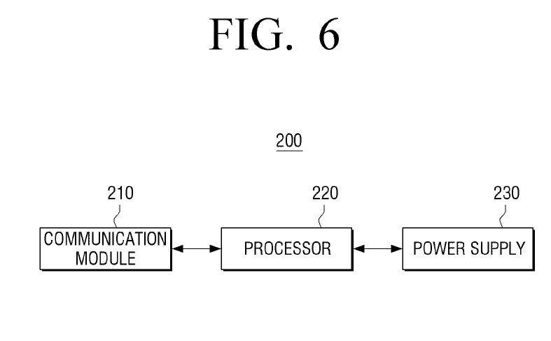

FIG. 6 is a block diagram illustrating an example configuration of an external apparatus according to an example embodiment.

Referring to FIG. 6, the external apparatus 200 includes a communication module (e.g., including communication circuitry) 210, a processor 220 and a power supply 230.

The communication module 210 includes various communication circuitry configured/configurable to perform a communication with the electronic apparatus 100, and since detailed configurations of the communication module 210 are similar to configurations of the communication module 110 of the electronic apparatus 100, the detailed configuration of the communication module 210 are omitted.

The processor 220 may control the communication module 210 to perform a finding operation which is repetitively performing a searching operation and a listening operation. Herein, the searching operation indicates an operation of transmitting a probe request packet to the electronic apparatus 100 and the listening operation indicates receiving the probe request packet from the electronic apparatus 100 and transmitting a probe response packet corresponding to the probe request packet. However, in the finding operation, the processor 220 may control the communication module 210 to repetitively perform only the listening operation without performing a searching operation. In other words, the processor 220 may control the communication module 210 to skip an operation to transmit a probe request packet to the electronic apparatus 100 and periodically repeat the listening operation only which is transmitting a probe response packet after receiving the probe request packet from the electronic apparatus 100. Therefore, since power in performing the searching operation may be saved, the processor 220 has an effect of reducing power consumption.

When a wake-up packet is received from the electronic apparatus 100, the processor 220 may perform a wake-up operation. Specifically, in a sleep mode, the processor 220 may control that minimum power is provided to the power 230, when a wake-up packet is received, the sleep mode is changed to the operation mode and the power 230 is provided with power to operate the external apparatus 200.

The power supply 230 provides power with each element in the external apparatus 200. The power supply 230 may be embodied as a switched-mode power supply (SMPS), or may be embodied by using a transformer or a rectifier circuit.

The power supply 230 may provide different power according to a mode of the external apparatus 200. For example, when the external apparatus 200 is in an operation mode, the power supply 230 may provide power with all elements of the external apparatus 200. When the external apparatus 200 is in the sleep mode, the power supply 230 may provide power with some elements to perform a searching operation and a listening operation or with some elements to perform only the listening operation. When the external apparatus 200 is turned off, the power supply 230 may stop providing power to the external apparatus 200.

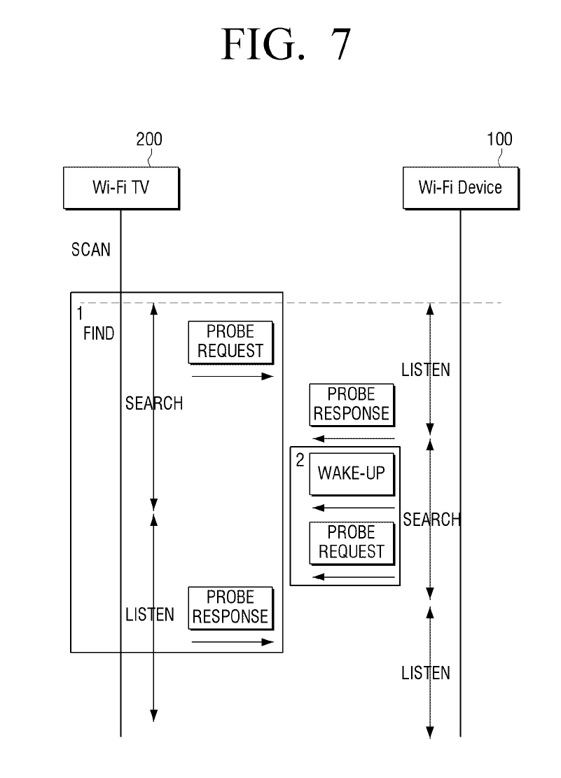

FIG. 7 is a diagram illustrating an example method of transceiving a packet with an external apparatus according to an example embodiment.

Referring to FIG. 7, the electronic apparatus 100 according to an example embodiment may be a Wi-Fi device and the external apparatus 200 may be a Wi-Fi television.

At scanning, the electronic apparatus 100 transmits a probe request packet to the external apparatus 200 and when the probe request packet is received, the external apparatus 200 transmits a probe response packet to the electronic apparatus 100. Also, the external apparatus 200 may transmit a probe request packet and the electronic apparatus 100 may transmit a probe response packet corresponding to the probe request packet.

At finding, the electronic apparatus 100 and the external apparatus 200 may repetitively perform a searching operation and a listening operation. The external apparatus 200 may skip the searching operation and only perform the listening operation periodically. In other words, the external apparatus 200 may, without transmitting a probe request packet, in response to a probe request packet being received from the electronic apparatus 100, only transmit a probe response packet corresponding to the probe request packet.

For example, when a probe request packet is transmitted at the searching of the external apparatus 200, the electronic apparatus 100, at the listening, transmits a probe response packet corresponding to the probe request packet received from the external apparatus 200 to the external apparatus 200. After then, the electronic apparatus 100 may transmit a probe request packet including a wake-up packet at the searching.

Even though FIG. 7 illustrates that the external apparatus 200 first transmits a probe request packet, it is not limited thereto, and it is also possible that electronic apparatus 100 first transmits a probe request packet to the external apparatus 200 and the external apparatus 200 transmits a probe response packet corresponding to the probe request packet received from the electronic apparatus 100. In this case, the electronic apparatus 100 may receive the probe response packet from the external apparatus 200, and include and transmit a wake-up packet in the probe request packet.

As described above, the electronic apparatus 100 may include and transmit a wake-up packet in a probe request packet in order to change a mode of the external apparatus 200 to an operation mode without performing a separate connecting operation.

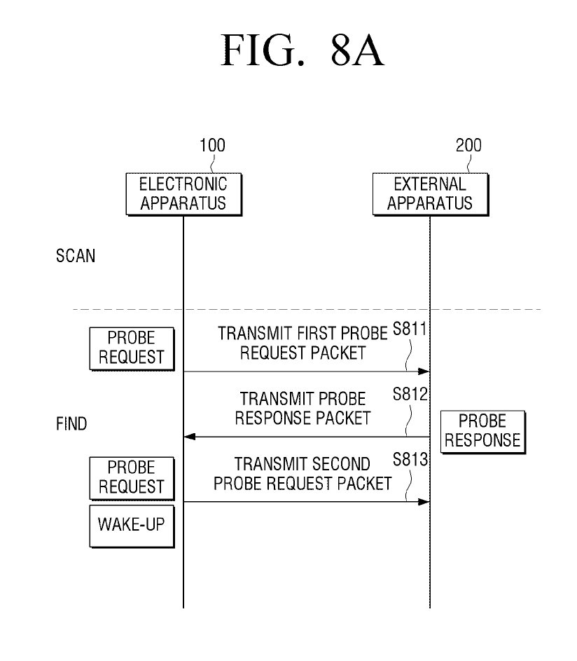

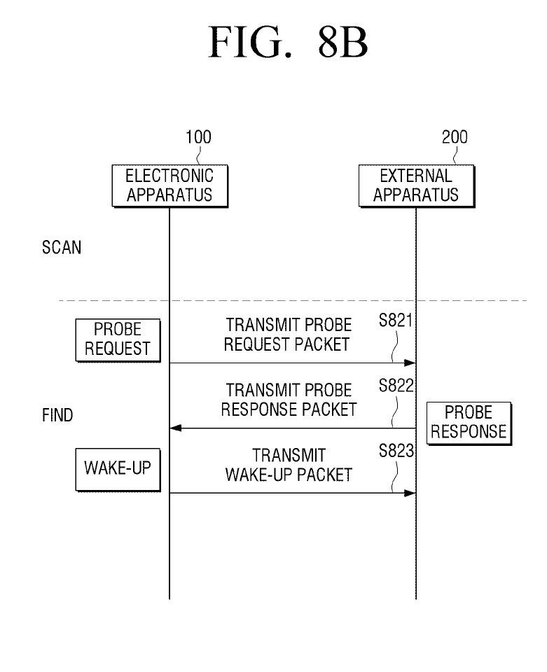

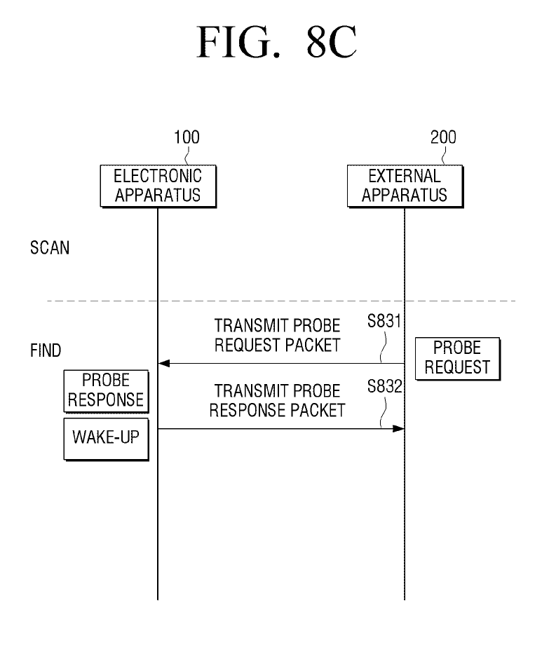

FIGS. 8A, 8B and 8C are diagrams illustrating an example method of transmitting a wake-up packet according to an example embodiment.

For example, referring to FIG. 8A, the electronic apparatus 100 may, after performing a scanning operation, at finding, transmit a first probe request packet to the external apparatus 200 (S811). When the first probe request packet is received from the electronic apparatus 100 at listening, the external apparatus 200 may transmit a probe response packet corresponding to the first probe request packet to the electronic apparatus 100 (S812). When the probe response packet is received from the external apparatus 200, the electronic apparatus 100 may include and transmit a wake-up packet in a second probe request packet (S813).

For another example, referring to FIG. 8B, the electronic apparatus 100 may, after performing the scanning operation, at finding, transmit a probe request packet to the external apparatus 200 (S821) and receive a probe response packet from the external apparatus 200 (S822). When the probe response packet is received from the external apparatus 200, the electronic apparatus 100 may transmit a separate wake-up packet to the external apparatus 200 (S823) and convert a mode of the external apparatus 200 to an operation mode.

For another example, referring to FIG. 8C, at the finding, the electronic apparatus 100 may receive a probe request packet from the external apparatus 200 (S831). In other words, the electronic apparatus 100 may receive a probe request packet of the external apparatus 200 by performing the listening operation and transmit a probe response packet corresponding to the probe request packet to the external apparatus 200. In this case, a wake-up packet may be included and transmitted in the probe response packet (S832). As a result, the electronic apparatus 100 may transmit the wake-up packet to the external apparatus 200 by performing the listening operation.

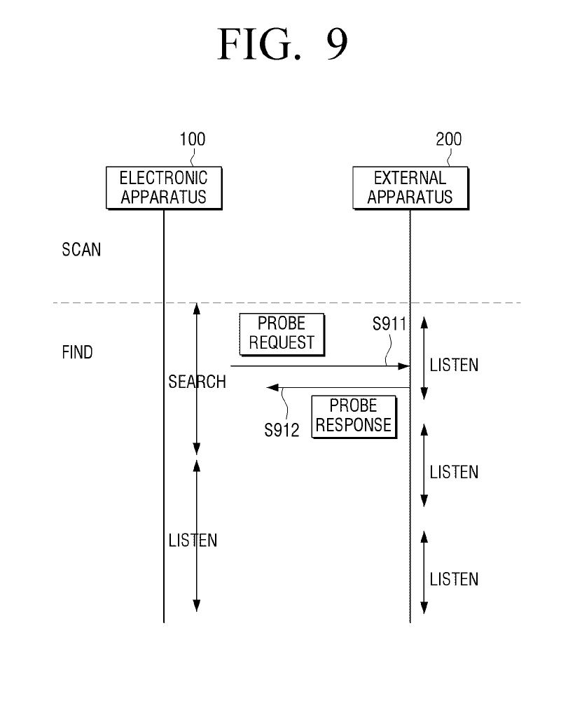

FIG. 9 is a diagram illustrating an example operation when an external apparatus is in a sleep mode according to an example embodiment.

Referring to FIG. 9, the electronic apparatus 100 and the external apparatus 200 may, after performing the scanning operation, perform a searching operation and a listening operation at the finding. The external apparatus 200 may reduce power consumption by periodically performing the listening operation only at the finding. In other words, after receiving a probe request packet from the electronic apparatus 100 (S911), by only performing the listening operation which is transmitting a probe response packet corresponding to the probe request packet (S912), an operation of transmitting a probe request packet to the electronic apparatus 100 may not be performed.

Also, the external apparatus 200 may not perform any operation at the searching and only perform an operation at the listening at the finding. In other words, the external apparatus 200 may be in a sleep mode at the searching and perform an operation only at the listening.

Therefore, the external apparatus 200 may, at the finding, periodically perform the listening operation only or the searching (the sleep mode) and the listening may be repetitively performed. Thereby, the example embodiment may be embodied with low power since the external apparatus 200 does not perform an operation of transmitting a probe request packet.

A mode of the external apparatus 200 may be converted to an operation mode by receiving a probe request packet including a wake-up packet from the electronic apparatus 100. In this case, for an embodiment with lower power, the external apparatus 200 may not transmit a probe response packet corresponding to the probe request packet received from the electronic apparatus 100 and convert a mode of the external apparatus 200 to the operation mode.

The electronic apparatus 100 may set different performing times for the searching operation and the listening operation to perform the finding operation more effectively.

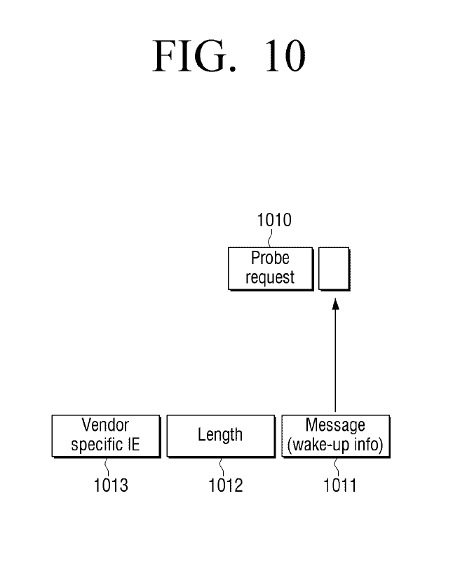

FIG. 10 is a diagram illustrating an example method of adding a wake-up packet to a probe request packet according to an example embodiment.

Referring to FIG. 10, the electronic apparatus 100 may include a wake-up packet in a probe request packet 1010 and transmit to the external apparatus 200. Specifically, the wake-up packet may include a message 1011, a length 1012 and a vendor specific information element (IE) 1013, and wake-up information may be included in the vendor specific IE 1013 and be added to a probe request packet.

However, the example embodiment is not limited thereto and the electronic apparatus 100 may perform a wake-up operation by transmitting a separate wake-up packet to the external apparatus 200. In other words, when transmitting the separate wake-up packet, the electronic apparatus 100 may constitute and transmit a wake-up packet which is a separate packet not including the message 1011, the length 1012 and the vendor specific IE 1013.

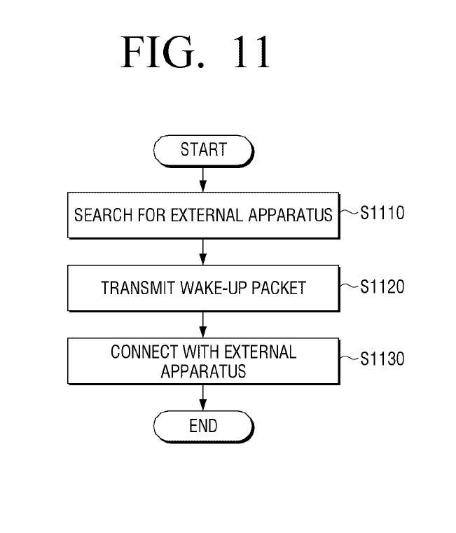

FIG. 11 is a flowchart illustrating an example method of controlling an electronic apparatus according to an example embodiment.

According to a method of an electronic apparatus illustrated in FIG. 11, an external apparatus which is connectable with an electronic apparatus is searched for (S1110).

A wake-up packet is transmitted to a searched or identified external apparatus (S1120).

When a mode of the external apparatus is converted to an operation mode by the wake-up packet, a communication connection with the external apparatus is performed (S1130).

Also, at operation S1110, the external apparatus may be searched by transmitting a first probe request packet to the external apparatus and receiving a probe response packet corresponding to the first probe request packet from the external apparatus.

At operation S1120, in response to the probe response packet corresponding to the first probe request packet being received from the external apparatus, a wake-up packet may be included and transmitted in the first probe request packet.

At operation S1120, the wake-up packet may be added and transmitted in a vendor specific IE included in a second probe request packet.

At operation S1110, in response to the probe request packet being received from the external apparatus, the external apparatus may be searched by transmitting a probe response packet corresponding to the probe request packet.

At operation S1110, in response to the probe request packet being received from the external apparatus, a wake-up packet may be included and transmitted in the probe response packet.

At operations S1110 and S1120, in response to there being a plurality of searched external apparatuses, a wake-up packet is transmitted to each of the plurality of external apparatuses and a communication connection may be performed with an external apparatus whose mode is converted to an operation mode among the plurality of external apparatuses.

At operation S1130, a communication connection may be performed with the external apparatus by using a W-Fi-P2P module.

According to the various example embodiments, since a wake-up packet can be transmitted even in the case that an electronic apparatus and an external apparatus are not connected to an access point, a convenience of a user is improved.

The methods according to the various example embodiments may be embodied by simply upgrading software of an existing electronic apparatus.

Also, a non-transitory computer readable medium in which a program for executing the control method is stored may be provided.

For example, there may be provided with a non-transitory computer readable medium storing a program which executes searching for an external apparatus connectable with an electronic apparatus, transmitting a wake-up packet to a searched external apparatus and in response to a mode of the external apparatus being changed to an operation mode by the wake-up packet, performing a communication connection with the external apparatus.

The non-transitory computer readable medium indicates a medium which can semi-permanently store data and which is readable by a device. Specifically, programs of performing the above-described various methods can be stored and can be provided in a non-transitory computer readable medium such as a compact disc (CD), a digital versatile disc (DVD), a hard disk, a Blu-ray disk, a universal serial bus (USB), a memory card, a ROM, or the like.

While various example embodiments of the disclosure have been illustrated and described, it will be understood by those skilled in the art that various changes in form and details can be made therein without departing from the spirit and scope of the present disclosure as defined by the appended claims. Therefore, the scope of the disclosure is defined not by the detailed description of example embodiments, but by the appended claims, and all differences within the scope will be construed as being included in the present disclosure.

What is claimed is:

1. An electronic apparatus, comprising:
communication circuitry configured to communicate with an external apparatus; and
a processor configured to control the communication circuitry to search for an external apparatus connectable with the electronic apparatus, to transmit a wake-up packet to the external apparatus identified by the search, and to perform a communication connection with the external apparatus in response to a mode of the external apparatus being changed to an operation mode by the wake-up packet.

2. The apparatus as claimed in claim 1, wherein the processor is configured to control the communication circuitry to transmit a first probe request packet to the external apparatus and to receive a probe response packet corresponding to the first probe request packet from the external apparatus to search for the external apparatus.

3. The apparatus as claimed in claim 2, wherein the processor is configured to control the communication circuitry to include and transmit a wake-up packet in a second probe request packet in response to a probe response packet corresponding to the first probe request packet being received from the external apparatus.

4. The apparatus as claimed in claim 3, wherein the processor is configured to control the communication circuitry to add and transmit the wake-up packet including a vendor specific information element included in the second probe request packet.

5. The apparatus as claimed in claim 1, wherein the processor is configured to control the communication circuitry to transmit a probe response packet corresponding to the probe request packet to search for the external apparatus in response to a probe request packet being received from the external apparatus.

6. The apparatus as claimed in claim 5, wherein the processor is configured to control the communication circuitry to include and transmit a wake-up packet in a probe response packet corresponding to the probe request packet in response to a probe request packet being received from the external apparatus.

7. The apparatus as claimed in claim 1, wherein the processor is configured to control the communication circuitry to transmit a wake-up packet to each of a plurality of external apparatuses and to perform a communication connection with an external apparatus of which mode is changed to an operation mode from among the plurality of external apparatuses in response to there being a plurality of external apparatuses identified by the search.

8. The apparatus as claimed in claim 1, wherein the communication circuitry comprises a Wi-Fi P2P module.

9. A system, comprising:
an electronic apparatus configured to search for an external apparatus connectable with the electronic apparatus, to transmit a wake-up packet to the external apparatus identified by the search, and in response to a mode of the external apparatus being changed to an operation mode by the wake-up packet, to perform a communication connection with the external apparatus; and
an external apparatus configured to change a mode to an operation mode in response to the wake-up packet being received from the electronic apparatus.

10. The system as claimed in claim 9, wherein the electronic apparatus is configured to transmit a probe request packet including the wake-up packet to the external apparatus, and
the external apparatus is configured to transmit a probe response packet corresponding to the probe request packet to the electronic apparatus in response to the probe request packet being received from the electronic apparatus.

11. The system as claimed in claim 10, wherein the external apparatus is configured to only periodically perform a listening operation in response to a mode of the external apparatus being a sleep mode, and is configured to transmit a probe response packet corresponding to the probe request packet to the electronic apparatus in response to the probe request packet being received from the electronic apparatus in a listening status.

12. A method of controlling an electronic apparatus, the method comprising:
searching for an external apparatus connectable with the electronic apparatus;
transmitting a wake-up packet from the external apparatus to the external apparatus identified by the searching; and
performing a communication connection with the external apparatus in response to a mode of the external apparatus being changed to an operation mode by the wake-up packet.

13. The method as claimed in claim 12, wherein the searching comprises transmitting a first probe request packet to the external apparatus and receiving a probe response packet corresponding to the first probe request packet from the external apparatus to search for the external apparatus.

14. The method as claimed in claim 13, wherein the transmitting comprises including and transmitting a wake-up packet in a second probe request packet in response to a probe response packet corresponding to the first probe request packet being received from the external apparatus.

15. The method as claimed in claim 14, wherein the transmitting comprises adding and transmitting the wake-up packet including a vendor specific information element included in the second probe request packet.

16. The method as claimed in claim 12, wherein the searching, in response to a probe request packet being received from the external apparatus, comprises transmitting a probe response packet corresponding to the probe request packet to search for the external apparatus.

17. The method as claimed in claim 16, wherein the transmitting, in response to a probe request packet being received from the external apparatus, comprises including and transmitting a wake-up packet in a probe response packet corresponding to the probe request packet.

18. The method as claimed in claim 12, wherein the transmitting, in response to there being a plurality of external apparatuses being identified, comprises transmitting a wake-up packet to each of the plurality of external apparatuses, and
wherein the performing a communication connection comprises performing a communication connection with an external apparatus of which mode is changed to an operation mode from among the plurality of external apparatuses.

19. The method as claimed in claim 12, wherein the performing a communication connection comprises performing a communication connection with the external apparatus using a Wi-Fi P2P module.
